(19) United States
(12) Patent Application Publication
(10) Pub. No.: US 2010/0221140 A1
(43) Pub. Date: Sep. 2, 2010

(54) HOT STEEL STRIP PARTICULARLY SUITED FOR THE PRODUCTION OF ELECTROMAGNETIC LAMINATION PACKS

(76) Inventor: Giovanni Arvedi, Cremona (IT)

Correspondence Address: Steinfl & Bruno, 301 N Lake Ave Ste 810, Pasadena, CA, 91101, US

(21) Appl. No.: 12/161,682

(22) PCT Filed: Jan. 26, 2006
(86) PCT No.: PCT/IT2006/000045

§ 371 Date: Jul. 21, 2008

(51) Int. Cl. C22C 38/44; C22C 38/40

(52) U.S. Cl. 420/108

(57) ABSTRACT

A hot rolled low carbon steel strip with a reduced content of silicon and thickness comprised between 0.65 and 1.5 mm can be used in a particularly advantageous way for the production of multilayer packs of cold cut lamination and all those products composed of a number of overlying steel sheets which are required to have a substantial parallelism, planarity and no burrs, providing a valid alternative solution to the cold rolled, non-oriented grain silicon steel strip which is usually employed to this purpose. Said steel strip is characterized by a silicon content <0.03%, a thickness preferably between about 0.65 and 1 mm, reduced tolerances of ±0.05 mm, a parallelism rate <0.02 mm and a fine and uniform grain structure with the 70% of the ferritic grains comprised between the grades 9 and 12 of the ASTM E 112 standard.

The present invention relates to a low carbon hot rolled steel strip having such features that it can replace, in producing cut lamination packs, such as stators and rotors of electric motors, the cold rolled strips till now used for these utilizations.

For example WO2004/013365 and EP1411138 disclose non-oriented grain magnetic strips provided with special chemical-physical features that, upon cold rolling and annealing treatment, render the same suitable to be used for producing, after cutting, lamination packs such as stators and rotors of electric motors.

It is also known that cold rolling involves a cycle of operations which is rather burdensome when considering the required costs and time. These strips of known type are further characterized by a relatively high content of silicon and by a structure with not particularly fine grains. It is known in fact that the steel strip that is commonly used in the technique for the above-mentioned utilizations generally shows a silicon content >0.5%, having a structure with ferritic grains not particularly fine and usually even lower than grade 7 of the ASTM standard, in order to enhance its magnetic permeability.

It is an object of the present invention to provide a low carbon hot rolled steel strip having a reduced silicon content and thickness comprised between 0.65 and 1.5 mm, which shows without subsequent cold rolling or additional treatments, particular metallurgical and geometrical features, as well as relating to planarity and hardness, which may render the same particularly, although not exclusively, suitable to the production of lamination that, upon cutting can form the multilayer packs suitable for the above-mentioned utilizations.

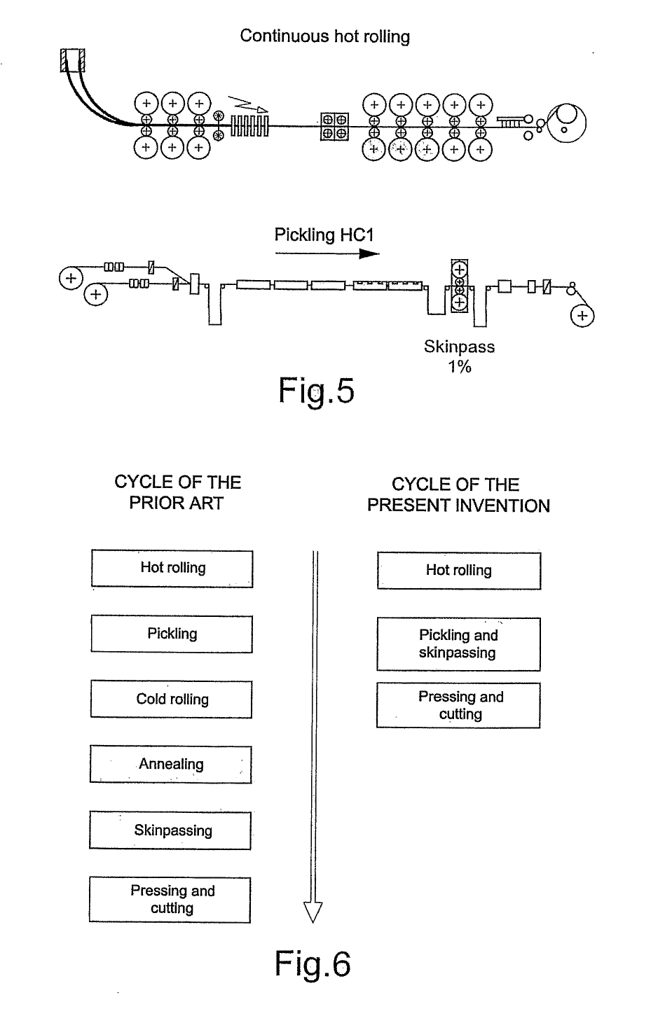

The strip according to the present invention is preferably, although not exclusively, manufactured by means of in-line systems of the “thin-slab” type, like the one described in the international publication WO 2004/026497 in the name of the same applicant, as schematically represented in FIG. 5, and this characterized, as set forth in claim 1, by a low silicon content (lower than 0.03%) and a structure the fineness of which is higher than grade 9 of the ASTM E 112 standard, with a thickness comprised between 0.65 and 1.5 mm, a parallelism rate <0.02 mm and a roughness ≧1.3 μm.

The mean thickness is preferably of 0.65-1.0 mm with strict tolerances of ±0.05 mm, whereas the parallelism is preferably even less than 0.01 mm. Upon possible pickling and skinpassing operations, the hardness of the strip according to the present invention can reach values of HRB 55/70 or HV110/140.

The particular roughness ≧1.3 μm of the strip is helpful to prevent the cut pieces from closely joining together when packed to form a multilayer, thanks to the air being present in the gaps caused by the roughness, and in general the above-described features make this type of hot rolled strip particularly suitable to a fine cutting without any need of having to trim and straighten the cut pieces, thereby rendering them ready for the subsequent packing steps, which in general are carried out in-line and automatically, thus eliminating the trimming and straightening operations which are required in the traditional systems.

These and other objects, advantages and features of the steel strip according to the invention will become clearer from the following detailed description with reference to the annexed drawings in which:

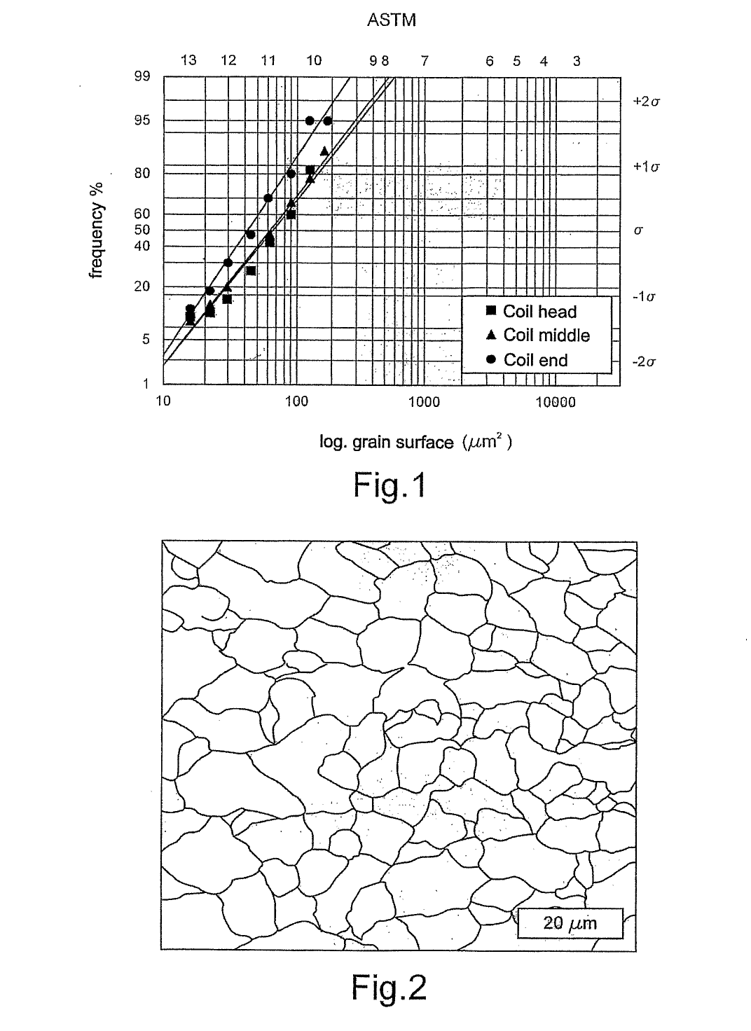

FIG. 1 shows, being graphically plotted, the curves of the frequency with which the presence of a given size of the grain has been statistically detected in a number of coils at the beginning, in the middle and at the end respectively of each coil of strip according to the present invention;

FIG. 2 shows a detail of the microstructure of the same strip, when seen with a magnification ×1000;

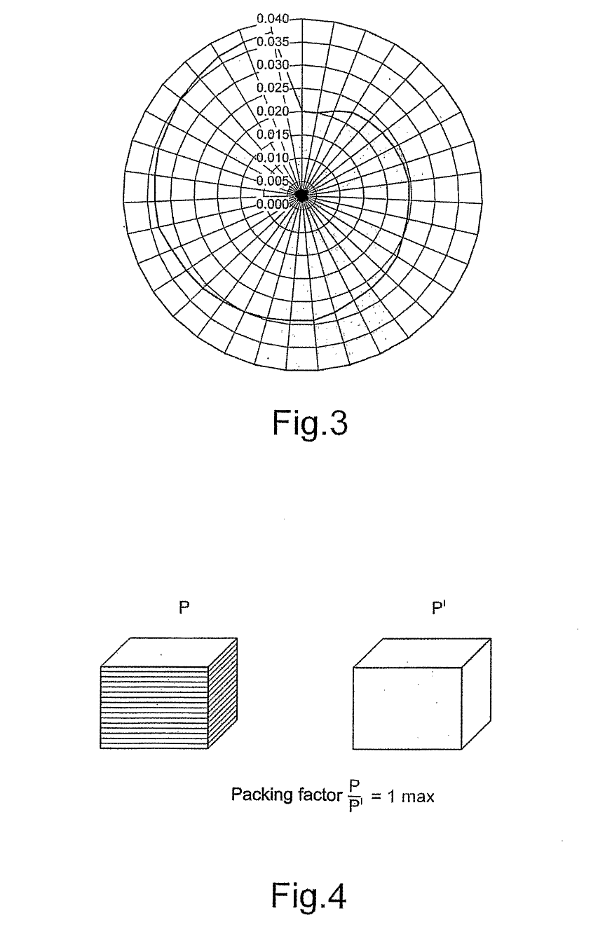

FIG. 3 shows a distribution of the burrs in mm, as experimentally detected on a number of pieces cut from a strip according to the present invention;

FIG. 4 schematically shows how is calculated the packing factor (rolling parameter according to the Italian standard UNI EN 10126) reference to which will be made in the following as indicator of parallelism and of the presence of burrs in the cut pieces of lamination;

FIG. 5 schematically shows a type of plant, such as that of the above-mentioned publication WO2004/026497, preferably used to manufacture the strip of the present invention; and

FIG. 6 shows a flow-chart of comparison between the manufacturing cycle of the strips according to the prior art and the present invention.

As already stated above, the hot rolled steel strip according to the present invention can replace, without annealing treatment, the cold rolled strips for producing, upon cutting, lamination packs of magnetic sheets. The thickness of said steel strip is of 0.65-1.5 mm, preferably 0.65-1.0 mm with strict tolerances of ±0.05 mm and parallelism rate <0.02, preferably 0.01 mm. While the magnetic strip according to the prior art is characterized by a silicon content >0.5% and a ferritic grain with fineness lower than grade 7 of ASTM E 112 standard to enhance the magnetic permeability, the strip according to the invention, in spite of the very low silicon content (<0.03%) and the grain fineness higher than grade 9 of the above-mentioned standard, shows magnetic features comparable with those of non-oriented grain silicon-based strips being hot rolled and subsequently annealed to increase the size of the ferritic grain. This appears to be due to the substantial uniformity of the ferritic grain, wherein the 70% of the grains show a fineness grade comprised between levels 9 and 12 of the above-mentioned ASTM standard, thus rendering particularly permeable the magnetism of the same strip. Although the grain size plays a basic role concerning the magnetic permeability of the steel, experimental tests have in fact shown that in this respect the feature of the grain uniformity is also very important, irrespective of its size.

With reference to FIG. 1 it can be observed how fine is the microstructure of the strips according to the invention in which in fact more than 80% of the grains has a size of less than that corresponding to grade 9 of the ASTM E 112 standard and thereby a fineness better than grade 9 itself.

The feature of uniformity of the ferritic grain, which is fine and particularly homogeneous, descends also in particular from the microphotograph magnified one thousand times as represented in FIG. 2.

Coming now to another feature of the strip according to the invention, i.e. the little height of the cutting burrs, the upper limit of which as requested on the market is of 0.04 mm, the graph of FIG. 3 clearly shows how such a limit is fully met by the strip of the invention, with which the value of 0.04 mm does not appear to have been reached.

In order to determine the features of planarity and parallelism of the steel strip, in relation with the product of the intended use, i.e. lamination packs of magnetic sheets, in particular but not exclusively for producing stators and rotors of electric motors, reference is usually made to a packing factor which is defined as a ratio between the weight of a multilayer packet of regular shape (P) and that of a solid steel block having the same size (P′). Obviously the highest value of packing factor that is possible to reach is equal to 1, as can be seen with reference to FIG. 4, where on the left side a multi layer packet is represented and a solid steel block on the right side. Through said factor P/P′ a measure of the parallelism of the multilayer pack is obtained, or in other words a check of the possible presence of gaps due to burrs or thickness unevenness. Experimental tests carried out on each position of the strip have shown that such a factor is very high, comparable with that of cold strips, which is comprised between 0.90 and 0.99, not only but in the field of the highest values corresponding to a parallelism grade <0.02 mm and even lower than 0.01 mm. The strip according to the present invention is produced in a plant such as the one schematically illustrated in FIG. 5, for the continuous hot rolling, such as of the type being the object of publication WO2004/026497, from which the strip according to the present invention can be obtained with the above indicated features. In particular the lower portion of the lay-out relates to the possible operations of pickling and skinpassing to which the strip from the rolling step can be subjected, thus being able to reach hardness values corresponding to HRB 55/70 or HV 110/140.

In the flow-chart of FIG. 6 there are clearly indicated on the right side the main steps of the manufacturing cycle of the strip according to the invention in a system of this type, thus pointing out the lower number of steps with respect to those of a manufacturing cycle according to the prior art, which involves the cold rolling, although the results of quality given are comparable.

That the strip according to the invention is a valid alternative solution to the cold rolled silicon-based strips with non-oriented grains, when the applications do not require particular limits of the magnetic features, has been proved by means of experimental tests which have given the results listed in the following table 1. It will be noted that these experimental tests have been carried out on multi-layer packs obtained from a strip of the present invention, in other words hot rolled without additional treatments, which have been compared with similar packs obtained from a strip of the prior art, that has been cold rolled, annealed and skinpassed (1%).

TABLE 1

| | W 1T | W 1.5T | B2500 | B5000 | B10000 |
|---|---|---|---|---|---|
| Strip according to the | 9.76 | 20.60 | 1.581 | 1.705 | 1.818 |
| invention State: Raw | | | | | |
| (Cycle 1) | | | | | |
| Strip of the Prior Art | 10.20 | 21.61 | 1.590 | 1.713 | 1.829 |
| State: Annealed (Cycle 2) | | | | | |

### Wherein:

WIT e W1.5T are the magnetic losses in Watt/Kg of steel, measured respectively with a magnetic induction (polarization) of 1.0 and 1.5 Tesla in an alternate field at 50 Hz;
B2500-B5000-B10000 are the magnetic induction values (polarization) in

Tesla, measured with intensity of magnetic field H alternate at 50 Hz, of 2500, 5000, 10000 A/m, respectively.
Cycle 1: hot rolling+pickling+skinpassing
Cycle 2: hot rolling+pickling+cold rolling (>70%)+annealing+skinpassing.

Through observations of the results listed in the table it can be noted that the performances of the hot rolled strip according to the invention are fully comparable, under the aspect of the quality, with those of a strip according to the prior art further subjected to cold rolling, annealing and skinpassing treatment. The values of magnetic permeability which have been found are in fact fairly similar (highest difference: 0.6% at B10000), while the magnetic losses are even lower with the strip of the invention.

It is also clear that the manufacturing of the steel according to the invention is more economical with respect to that of steel according to the prior art both for addition of less quantities of silicon and for the elimination of the cold rolling and annealing steps, as already remarked above. This saving can reach a value corresponding to about an amount of 15% of the total manufacturing costs.

Another advantage of the steel according to the invention is that of avoiding the critical state of the traditional non-oriented grain silicon steel, the slabs of which must be heated at temperatures higher (by about 200° C.) than requested by the other steels which do not include silicon and must be cooled more slowly with a controlled process before the subsequent rolling step to avoid cracks on the slab itself. Finally it is given in the following a typical example of chemical analysis of the strip according to the invention, when bearing in mind that it is not the case of a binding composition, except for the lower carbon and silicon content, as already mentioned before: C≦0.06%, Mn 0.10÷0.20%, Si<0.03%, P≦0,010%, S≦0.005%, Cr≦0.10%, Ni≦0.12%, Mo≦0.03%, Al 0.030±0.050%.

1.-7. (canceled)

8. A hot rolled steel strip for manufacturing electrical steel sheet,
the hot rolled steel strip having a thickness comprised between 0.65 and 1.5 mm and a fine grain structure,
the hot rolled steel strip having a composition: C≦0.06%, Mn 0.10-0.20%, Si<0.03%, P≦0.010%, S≦0.005%, Cr≦0.10%, Ni≦0.12%, Mo≦0.03%, Al 0.030-0.050%, balance Fe and impurities,
the hot rolled steel strip showing a parallelism rate 0.02 mm,
wherein at least 70% of ferritic grains are between grades 9 and 12 of the ASTM E112 standard.

9. The hot rolled steel strip according to claim 8, wherein at least 80% of the ferritic grains are above grade 9 of the ASTM El 12 standard.

10. The hot rolled steel strip according to claim 8, having a thickness between 0.65 and 1 mm with thickness tolerances of ±0.05 mm.

11. The hot rolled steel strip according to claim 8, showing a parallelism rate <0.01 mm.

12. The hot rolled steel strip of claim 8, further showing a roughness ≦1.3 μm.

13. The hot rolled steel strip according to claim 11, showing a packing factor (P/P′)≧0.90.

14. The hot rolled steel strip according to claim 12, showing a packing factor (P/P′)≧0.90

15. The hot rolled steel strip according to claim 8, showing, after pickling and skinpassing, hardness values of HRB 55/70 or HV 110/140.

16. The hot rolled steel strip of claim 8, obtained by a process devoid of annealing and cold rolling steps.
